(19) United States
(12) Patent Application Publication
(10) Pub. No.: US 2024/0262412 A1
(43) Pub. Date: Aug. 8, 2024

(54) DRIVE MEMBER CONTROL APPARATUS

(71) Applicant: DENSO CORPORATION, Kariya-city (JP)

(72) Inventor: Daisuke Yato, Kariya-city (JP)

(73) Assignee: DENSO CORPORATION, Kariya-city (JP)

(21) Appl. No.: 18/638,241

(22) Filed: Apr. 17, 2024

Related U.S. Application Data
(63) Continuation of application No. PCT/JP2022/031971, filed on Aug. 25, 2022.

(30) Foreign Application Priority Data
Oct. 18, 2021 (JP) 2021-170269

(51) Int. Cl. B62D 5/04

(52) U.S. Cl. CPC B62D 5/046; B62D 5/0484

(57) ABSTRACT

A drive member control apparatus is provided with a control unit that controls a motor for driving a drive member and restricts a power supply to the motor when an estimated motor temperature reaches an operation restriction threshold temperature. The control unit is configured to set, at power ON, when determined that a control is terminated abnormally in a previous cycle, a difference between the operation restriction threshold temperature and the estimated motor temperature to be less than a maximum value.

### CROSS-REFERENCE OF RELATED APPLICATIONS

This application is the U.S. bypass application of International Application No. PCT/JP2022/031971 filed on Aug. 25, 2022, which designated the U.S. and claims priority to Japanese Patent Application No. 2021-170269 filed on Oct. 18, 2021, the contents of these are incorporated herein by reference.

### BACKGROUND

### Technical Field

The present disclosure relates to a drive member control apparatus.

### Description of the Related Art

Conventionally, as a drive member control apparatus for a power window control apparatus or the like, an apparatus is known including a control unit that restricts a power supply to a motor depending on an estimated motor temperature to prevent burnout of the motor. According to the drive member control apparatus, the estimated motor temperature is memorized at power OFF and the motor temperature is estimated at power ON based on the memorized estimated motor temperature.

### SUMMARY

As a first aspect of the present disclosure, a drive member control apparatus is provided with a control unit that controls a motor for driving a drive member and restricts a power supply to the motor when an estimated motor temperature reaches an operation restriction threshold temperature. The control unit is configured to set at power ON, when determined that a control is terminated abnormally (i.e. abnormal process) in a previous cycle, a difference between the operation restriction threshold temperature and the estimated motor temperature to be less than a maximum value.

### BRIEF DESCRIPTION OF THE DRAWINGS

The above-described objects and other objects, features and advantages of the present disclosure will be clarified further by the following detailed description with reference to the accompanying drawings. The drawings are:

FIG. 1 is a schematic circuit diagram related to a power window apparatus according to an embodiment;

FIG. 2 is a flowchart showing an estimated motor temperature setting process executed by a control unit according to an embodiment;

FIG. 3 is a characteristics diagram of a motor temperature with respect to time according to an embodiment;

FIG. 4 is a characteristics diagram of a motor temperature with respect to time according to an embodiment; and

FIG. 5 is a characteristics diagram of a motor temperature with respect to time according to another example.

### DETAILED DESCRIPTION OF THE PREFERRED EMBODIMENTS

Conventionally, as a drive member control apparatus for a power window control apparatus or the like, for example, JP-A-2019-106767 discloses an apparatus including a control unit that restricts a power supply to a motor depending on an estimated motor temperature to prevent burnout of the motor. According to the drive member control apparatus, the estimated motor temperature is memorized at power OFF and the motor temperature is estimated at power ON based on the memorized estimated motor temperature.

According to the above-described drive member control apparatus, for example, in the case where a battery is removed before powering-OFF in the normal process such as when an ignition switch is OFF, which causes the control unit to terminate the control abnormally with an abnormal process, the estimated current motor temperature is not memorized. Thus, at power ON where the igniting switch is caused to be ON in the next time, the estimated current motor temperature may be estimated based on older estimated motor temperature memorized at a time when the power is OFF in a normal process. Therefore, at power ON after the control was terminated abnormally with an abnormal process, for example, an estimated motor temperature decreased to reach a minimum motor temperature similar to the ambient temperature, which is deviated from the actual motor temperature, may be set. This may cause the motor to continuously operate although the actual motor temperature is close to the operation restriction threshold temperature, and further cause a motor burnout.

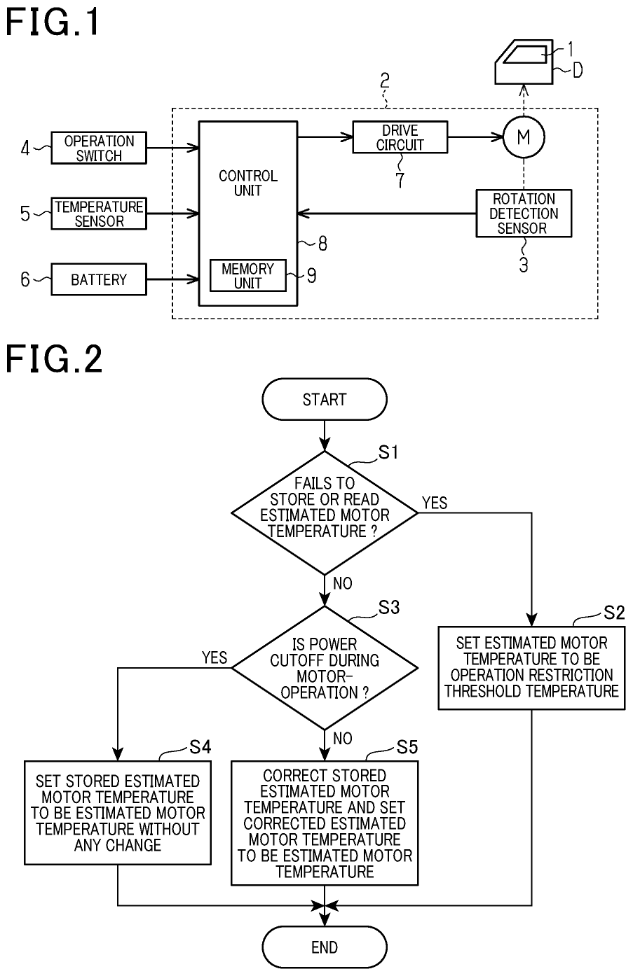

Hereinafter, with respect to FIGS. 1 to 4, an embodiment of a power window control apparatus will be described. As shown in FIG. 1, a motor M disposed in a power window apparatus 2 as a driven member control apparatus is coupled, via a regulator (not shown), to a window glass 1 as a driven member provided at a vehicle door D. When driving the motor M, the window glass 1 is driven to be opened or closed.

### Configuration of Power Window Apparatus 2

A power window apparatus 2 is provided with a rotation detection sensor 3 such as Hall IC that detects a rotation speed of a motor M. The power window apparatus 2 is provided with a control unit 8 that controls a duty ratio of a drive circuit 7 based on a signal from the rotation detection sensor 3, a signal from an operation switch 4, a signal from a temperature sensor 5 and a voltage of a battery 6 to supply a drive voltage to the motor M. Note that the temperature sensor 5 according to the present embodiment serves as an outside temperature sensor that detects an outside temperature to be displayed on a vehicle display for example. The control unit includes a memory unit 9. The memory unit 9 is a non-volatile memory such as NVRAM that stores various pieces of information including thresholds set in advance and configured as a rewritable memory. The control unit 8 may be configured as circuitry including 1) one or more processors that executes various processes in accordance with a computer program (i.e. software), 2) one or more dedicated hardware circuit such as application specific integrated circuit (ASIC) and 3) a combination of these 1) and 2). The processor includes a CPU, a memory such as RAM and ROM, and stores program codes or commands configured to cause the CPU to execute the processes. The memory, that is, a computer readable media may include media capable of being accessed by a general or dedicated computer.

The control unit 8 supplies the motor M with a power to open or close the window glass 1 responding to an operation of the operation switch 4 for example.

Further, the control unit 8 estimates an estimated motor temperature A. For example, the control unit 8 estimates, based on the drive voltage to be supplied to the motor M, the rotation speed acquired from the rotation detection sensor 3, an elapsed time and an ambient temperature Z acquired from the temperature sensor 5. For example, the control unit 8, once driving the motor M, gradually increases the estimated motor temperature A. The control unit 8 gradually decreases the estimated motor temperature A depending on the elapsed time from a time when driving of the motor M is stopped. The control unit set the estimated motor temperature A to be the ambient temperature Z as a minimum motor temperature when the motor M has not been driven for a long period of time.

Furthermore, the control unit 8 of the present embodiment restricts the power supply to the motor M when the estimated motor temperature A reaches an operation restriction threshold temperature X1 which is set in advance. Note that the operation restriction threshold temperature X1 is set to be a value smaller than an upper limit temperature at which the motor M may become burnt out.

The control unit 8 stores an estimated temperature A at a time when the power is OFF where the control is terminated with a normal process responding to switch-OFF operation of the ignition switch, into the memory unit 9. Then, the control unit 8 sets the estimated motor temperature A at power ON where the ignition switch is ON depending on the estimated motor temperature A or the like which is read from the memory unit 9. The control unit 8 according to the present embodiment sets, when the power is ON, a difference between the operation restriction threshold temperature X1 and the estimated motor temperature A to be less than the maximum value, responding to a determination where the control was terminated abnormally (i.e. abnormal process) in the previous cycle. Note that the maximum value of the difference between the operation restriction threshold temperature X1 and the estimated motor temperature A refers to a difference between a value at which the estimated temperature A becomes a minimum motor temperature, that is, the ambient temperature Z, and the operation restriction threshold temperature X1. Hence, in other words, the control unit 8 sets, when the power is ON, the difference between the operation restriction threshold temperature X1 and the estimated motor temperature A to be smaller than a difference between the operation restriction threshold temperature X1 and the minimum motor temperature, responding to a determination where the control was terminated abnormally (i.e. abnormal process) in the previous cycle. Further, the control unit 8 according to the present embodiment determines, based on an event that the battery 6 is removed during the motor M being operated which causes a power shutdown, or if the estimated motor temperature A fails to be stored or failed to be read in the previous cycle, that the control was terminated abnormally (i.e. abnormal process) in the previous cycle. Also, for example, the control unit 8 determines that the power is cutoff during operation of the motor M in the case where a flag already indicates ‘1’ at power ON, the flag usually indicating ‘1’ when the motor M is operating and ‘0’ when operation is terminated normally.

Specifically, firstly, the control unit 8 according to the present embodiment stores the estimated motor temperature A into the memory unit 9 at a time not only when the power is OFF but also at a time when the estimated motor temperature A increases in a period from the power ON to the power OFF. Specifically, the control unit 8 according to the present embodiment stores, every time when the motor M terminates one operation, the estimated motor temperature A into the memory unit 9.

Then, when the control unit 8 determines at power ON that the control was terminated abnormally (i.e. abnormal process) at the previous cycle, based on a power-cutoff occurring while the motor M was operating, the control unit 8 sets the stored estimated motor temperature A to be the current estimated temperature A without any change regardless of the elapsed time or the like. Note that the estimated motor temperature A to be set is the latest estimated motor temperature A among the estimated motor temperature A data including the estimated motor temperature A stored at a time when the estimated motor temperature A increased in the period from the power ON to the power OFF.

Further, when determined at power ON, that the control was terminated abnormally (i.e. abnormal process) at the previous cycle, due to a failure of storing or reading the estimated motor temperature A, the control unit 8 sets the estimated motor temperature A to be an operation restriction threshold temperature X1.

### Operation, Effects And Advantages of the Power Window Apparatus 2

Next, with reference to specific operation, effects and advantages of the power window 2 will be described.

As shown in FIG. 2, the control unit 8 executes, at power on where the ignition switch is turned ON, an estimated motor temperature setting process at steps subsequent to step S1. At step S1, the control unit 8 executes a process for reading the estimated motor temperature A stored in the memory unit 9, determines whether there is a failure to store or read the estimated motor temperature A, and moves to step S2 when determined that it has failed to store or read the estimated motor temperature A. Also, the control unit 8 proceeds to step S3 when determined failure to store or read the estimated motor temperature A has not occurred.

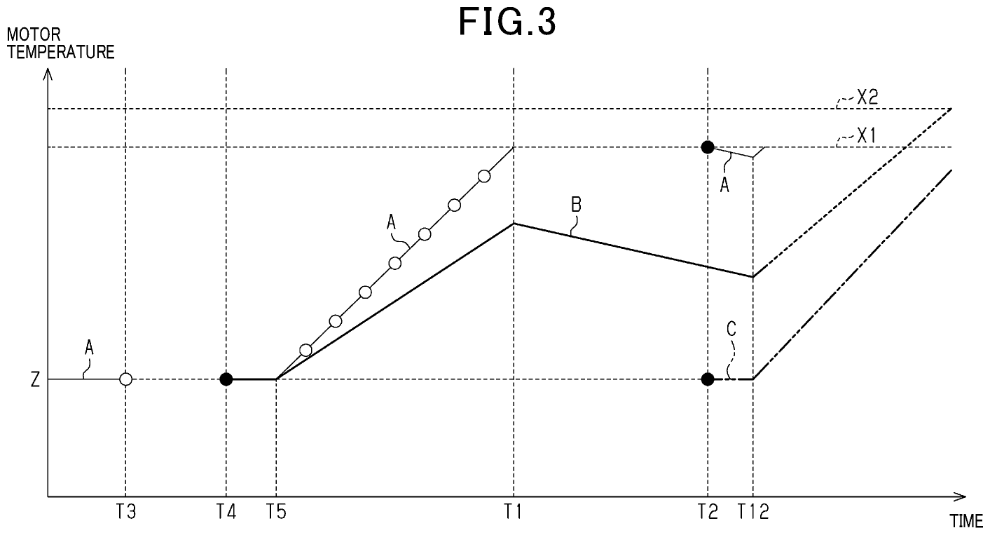

At step S2, the control unit 8 sets the estimated motor temperature A to be the operation restriction threshold temperature X1. For example, as shown in FIG. 3, in the case where the control is terminated at time T1 with an abnormal process and fails to store the estimated motor temperature A and then fails to read the estimated motor temperature A when the power is turned ON at time T2, the estimated motor temperature A is set to be the operation restriction threshold temperature X1. Note that the white circle in FIG. 3 indicates that the estimated temperature A is stored and the black circle in FIG. 3 indicates that the estimated motor temperature A is set. Also, FIG. 3 illustrates a trend of the actual motor temperature B, an estimated motor temperature C estimated by a control unit according to a conventional art or the like and an ambient temperature Z. Further, FIG. 3 illustrates an estimated motor temperature A in the case where the power is OFF at time T3 and the control is terminated with the normal process, and then the power is ON at time T4. Moreover, FIG. 3 illustrates an estimated motor temperature A in the case where the motor M is repeatedly driven in order to repeat open and close operations of the window glass 1 from a time T5 to time T1 after time T4.

The control unit 8 determines whether the power was turned OFF during the motor M operation in the previous cycle at step S3, and proceeds to step S4 when determined that the power was turned OFF. The control unit 8, when determined that the power was not turned OFF, proceeds to step S5.

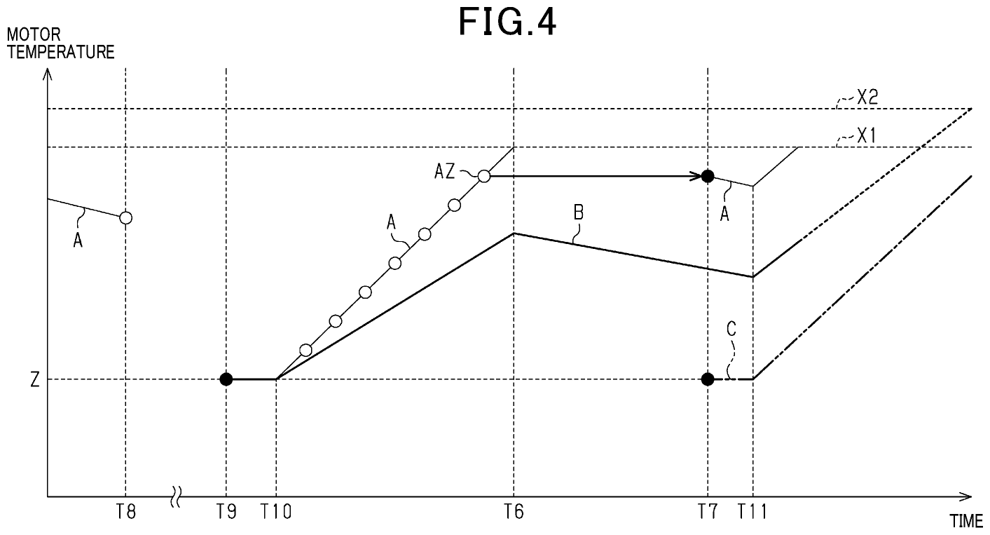

At step S4, the control unit 8 sets the stored estimated motor temperature A to be the estimated motor temperature A without any change regardless of the elapsed time. For example, as shown in FIG. 4, at time T6, when the power is turned OFF during the motor M operation and the control is terminated abnormally (i.e. abnormal process), the control unit 8 sets, at time T7 where the power is turned ON, the estimated motor temperature AZ stored in the last to be the estimated motor temperature A without any change. Note that the white circle in FIG. 4 indicates that the estimated motor temperature A is stored, and the black circle in FIG. 4 indicates that the estimated motor temperature A is set. FIG. 4 illustrates a trend of the actual motor temperature B, an estimated motor temperature C estimated by a control unit according to a conventional art or the like and an ambient temperature Z.

At step S5, the control unit 8 corrects the stored estimated motor temperature A using the elapsed time and sets the corrected estimated motor temperature A. For example, as shown in FIG. 4, when the control is terminated at time T8 with a normal process, the control unit 8 sets a lower estimated motor temperature A at power ON (i.e. time T9) in which the stored estimated motor temperature A is corrected with the elapsed time. Note that FIG. 4 illustrates a case where the time between the time T8 and time T9 is relatively long, and the estimated motor temperature A set at time T9 is the same as the ambient temperature Z. Moreover, FIG. 4 illustrates an estimated motor temperature A in the case where the motor M is repeatedly driven in order to repeat open and close operations of the window glass 1 from a time T10 to time T6 after time T6.

Then, when terminating the estimated motor temperature setting process as described above, thereafter, the control unit 8 calculates the estimated motor temperature at every control period until the power is OFF for the estimation. Then, the control unit 8 restricts the power supply to the motor M depending on the estimated motor temperature A. When the estimated motor temperature A reaches the operation restriction threshold temperature X1, the power suppled to the motor M is stopped so as to suppress further heat-generation and the burnout is avoided.

Next, effects and advantages of the above-described present embodiment will be described.

(1) At power ON, a difference between the operation restriction threshold temperature X1 and the estimated motor temperature A is set to be less than the maximum value, depending on a determination that the control was terminated abnormally (i.e. abnormal process) in the previous cycle. Thus, it is avoided to set the lowest motor temperature, as a low estimated motor temperature deviated from the actual motor temperature B, similar to the ambient temperature to be the estimated motor temperature A at that time. Further, the motor M is prevented from continuously operating until the temperature reaches the operation restriction threshold temperature X1 in the normal operation. Hence, the motor M can be prevented from being burnt out even when the control is terminated abnormally (i.e. abnormal process).

(2) Not only is the estimated motor temperature A is stored at a time of power OFF, but also the estimated motor temperature A is stored at a time when the estimated motor temperature A increases during a period from the power ON to the power OFF. With this configuration, an estimated motor temperature A close to the actual motor temperature B, which is unable to be stored at a time of power OFF only with storing the estimated motor temperature A, can be stored even when the control is terminated abnormally (i.e. abnormal process).

For example, at power ON and determined that the control was terminated abnormally (i.e. abnormal process) in the previous cycle, based on the power-cutoff during the motor M operating, the stored estimated motor temperature A is set to be the current estimated motor temperature A without any change. With this configuration, an estimated motor temperature A is utilized, which is close to the actual motor temperature B and not corrected towards the lower temperature side, whereby the motor M can be prevented from being burnt out. For example, as shown in FIG. 4, at time T7, since the estimated motor temperature A which is close to the actual motor temperature B and not corrected in the lower is utilized, even when the motor M is driven at time T11, the temperature reaches the operation restriction threshold temperature X1 faster, whereby the motor M can be prevented from being burnt out.

Further, for example, at power ON and it is determined that the control is terminated abnormally (i.e. abnormal process) in the previous cycle, due to a failure of storing or reading the estimated motor temperature A, the estimated motor temperature A is set to be the operation restriction threshold temperature X1. That is, when the power is ON and determined that the control was terminated abnormally (i.e. abnormal process) in the previous cycle, due to a failure to store or read the estimated motor temperature A, since there is no reason for estimating the actual motor temperature B, the estimated motor temperature A is assumed to be the operation restriction threshold temperature X1. Hence, the motor M can be prevented from being burnt out. For example, as shown in FIG. 3, since the estimated motor temperature A is set to be the operation restriction threshold temperature X1 at time T2, even when the motor M is driven at time T12, and the temperature reaches the operation restriction threshold temperature X1 faster, the motor M can be prevented from being burnt out.

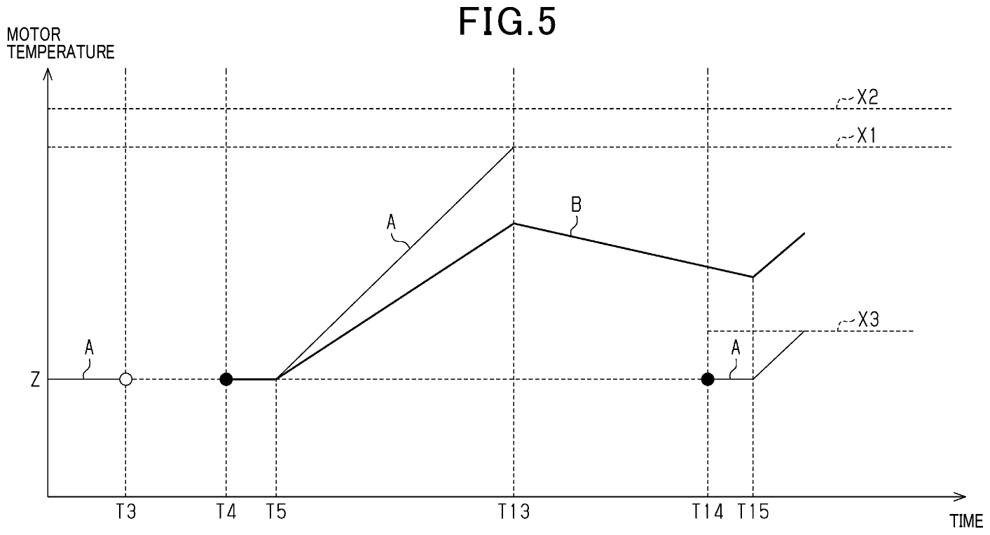

The present embodiment may be modified in the following manner. The present embodiment and the following modification examples may be mutually combined and embodied as long as no technical inconsistency is present. According to the present embodiment, the control unit 8 sets the estimated motor temperature A at power ON in accordance with a determination in which the control is terminated abnormally (i.e. abnormal process) in the previous cycle. However, it is not limited thereto. The operation restriction threshold temperature X1 may be temporarily changed. That is, the control unit 8, when it is determined that the control was terminated abnormally (i.e. abnormal process) in the previous cycle, may set the operation restriction threshold temperature to be an operation restriction threshold temperature X3 of an abnormal termination (see FIG. 5) in the power ON, which is lower than the operation restriction threshold temperature X1 of a normal termination. In this case, the control unit 8 may not store the estimated motor temperature A at a time when the estimated motor temperature A increases in a period from the power ON to the power OFF.

For example, as shown in FIG. 5, when the control is terminated abnormally (i.e. abnormal process) at time T13, the operation restriction threshold temperature X3 of the abnormal termination which is smaller than the operation restriction threshold temperature X1 of the normal termination is set at time T14 at power ON. At time T14, an estimated motor temperature A is set, which is the same as the ambient temperature Z stored at time T3 since the control is terminated abnormally (i.e. abnormal process) in the previous cycle. However, when the power is ON at time T14, since the operation restriction temperature X3 corresponding to an abnormal operation is set which is smaller than the operation restriction temperature X1 corresponding to a normal operation, even when the motor M is driven at time T15, the temperature reaches the operation restriction threshold temperature X3 faster. Hence, the motor M can be prevented from being burnt out.

According to the above-described embodiments, the control unit 8 is configured to set different estimated motor temperature A depending on whether the power is cutoff during an operation of the motor M or it fails to store or read the estimated motor temperature A. However, this is not limited thereto.

For example, at power ON, the control unit 8 may set, when determined that the control is terminated abnormally (i.e. abnormal process) in the previous cycle, the estimated motor temperature A to be the operation restriction threshold temperature X1 even when the power is cutoff during the operation of the motor M.

Also, when the power is cutoff during operation of the motor M in the previous cycle, the control unit 8 may set the stored estimated motor temperature A to be the current estimated motor temperature A without any change, and may prohibit power supply to the motor M if a failure to store or read the estimated motor temperature A occurs.

According to the above-described embodiments, the operation restriction threshold temperature X1 is set to be a temperature for forcibly stopping the power supply to the motor M when the estimated motor temperature A reaches the operation restriction threshold temperature X1. However, it is not limited thereto. For example, the operation restriction threshold temperature X1 may be set to be a temperature for prohibiting further operation of the motor M when the estimated motor temperature A reaches the operation restriction threshold temperature X1.

According to the above-described embodiments, the control unit 8 determines that the control is terminated abnormally (i.e. abnormal process), based on a cutoff of the power during the operation of the motor M or a failure of storing or reading the estimated motor temperature A. However, the control unit 8 may determine based on other conditions.

According to the above-described embodiments, the control unit 8 is configured to store the estimated motor temperature A every time when the motor M ends a single operation. However, the control unit 8 may store the estimated motor temperature A at other timing at which the estimated motor temperature A increases during a period from when the power is switched ON to when the power is switched OFF. For example, the control unit 8 may be configured to store the estimated motor temperature A at time when a predetermined period (e.g. 2 seconds or 3 seconds) elapses during the operation of the motor M in addition to a time when the motor M ends one operation.

According to the above-described embodiments, the control unit 8 is configured to estimate the estimated motor temperature A based on the drive voltage, the rotation speed, the elapsed time and the ambient temperature Z. However, it is not limited thereto. The estimated motor temperature A may be estimated based on other information. For example, an ammeter that detects a drive current of the motor M may be provided in the power window apparatus 2, and may estimate the estimated motor temperature A based on a current value acquired by the ammeter.

According to the above-described embodiments, embodiments are applied to the power window apparatus 2 where the drive member is the window glass 1. However, it is not limited thereto. The embodiments may be applied to another drive member control apparatus for driving another drive member.

The present disclosure has been described in accordance with the embodiments. However, the present disclosure is not limited to the embodiments and structure thereof. The present disclosure includes various modification examples and modifications within the equivalent configurations. Further, various combinations and modes and other combinations and modes including one element or more or less elements of those various combinations are within the range and technical scope of the present disclosure.

### Conclusion

The present disclosure is to provide a drive member control apparatus capable of preventing a motor from suffering burnout even when the control is terminated abnormally with an abnormal process.

As first aspect of the present disclosure, a drive member control apparatus is provided with a control unit that controls a motor for driving a drive member and restricts a power supply to the motor when an estimated motor temperature reaches an operation restriction threshold temperature. The control unit is configured to set at power ON, when determined that a control is terminated abnormally (i.e. abnormal process) in a previous cycle, a difference between the operation restriction threshold temperature and the estimated motor temperature to be less than a maximum value.

According to the above configuration, at power ON, a difference between the operation restriction threshold temperature and the estimated motor temperature is set to be less than the maximum value, depending on a determination that the control was terminated abnormally (i.e. abnormal process) in the previous cycle. Thus, for example, a minimum motor temperature similar to the ambient temperature as a lower estimated motor temperature deviated from the actual motor temperature can be prevented from being set as an estimated current motor temperature and the motor can be prevented from continuously operating until the operation restriction threshold temperature in the normal operation. Accordingly, even when the control is terminated abnormally (i.e. abnormal process), the motor can be prevented from being burnt out.

What is claimed is:

1. A drive member control apparatus comprising:
a control unit that controls a motor for driving a drive member and restricts power supply to the motor when an estimated motor temperature reaches an operation restriction threshold temperature,
wherein
the control unit is configured to, at power-on, in response to determining that control terminated abnormally in a previous cycle, set a difference between the operation restriction threshold temperature and the estimated motor temperature to be less than a maximum value;
the control unit is configured to store the estimated motor temperature at a time not only when the power is OFF but also at a time when the estimated motor temperature increases in a period from when a power is ON to when a power is OFF;
the control unit is configured to set, at power ON, when determined that a control is terminated abnormally in a previous cycle based on a power-cutoff during the motor operating, the estimated motor temperature stored at a time when the estimated motor temperature increases in a period from when a power is ON to when a power is OFF, to be a current estimated motor temperature without any change; and
the control unit is configured to set, at power ON, when determined that a control is terminated abnormally in a previous cycle due to a failure of storing or reading the estimated motor temperature, the estimated motor temperature to be the operation restriction threshold temperature.

2. A drive member control apparatus comprising:
a control unit that controls a motor for driving a drive member and restricts power supply to the motor when an estimated motor temperature reaches an operation restriction threshold temperature,
wherein
the control unit is configured to, at power-on, in response to determining that control terminated abnormally in a previous cycle, set a difference between the operation restriction threshold temperature and the estimated motor temperature to be less than a maximum value;
the control unit is configured to store the estimated motor temperature at a time not only when the power is OFF but also at a time when the estimated motor temperature increases in a period from when a power is ON to when a power is OFF; and
the control unit is configured to set, at power ON, when determined that a control is terminated abnormally in a previous cycle, the estimated motor temperature stored at a time when the estimated motor temperature increases in a period from when a power is ON to when a power is OFF, to be a current estimated motor temperature without any change.

3. A drive member control apparatus comprising:
a control unit that controls a motor for driving a drive member and restricts power supply to the motor when an estimated motor temperature reaches an operation restriction threshold temperature,
wherein
the control unit is configured to, at power-on, in response to determining that control terminated abnormally in a previous cycle, set a difference between the operation restriction threshold temperature and the estimated motor temperature to be less than a maximum value;
the control unit is configured to store the estimated motor temperature at a time not only when the power is OFF but also at a time when the estimated motor temperature increases in a period from when a power is ON to when a power is OFF;
the control unit is configured to set, at power ON, when determined that a control is terminated abnormally in a previous cycle based on a power-cutoff during the motor operating, the estimated motor temperature stored at a time when the estimated motor temperature increases in a period from when a power is ON to when a power is OFF, to be a current estimated motor temperature without any change.
